(19) United States
(12) Patent Application Publication
(10) Pub. No.: US 2005/0283822 A1
(43) Pub. Date: Dec. 22, 2005

(54) System and method for policy-enabling electronic utilities

(75) Inventors: Karen Appleby, Ossining, NY (US); Seraphin Bernard Calo, Cortlandt Manor, NY (US); James Ryan Giles, Evansville, IN (US); Guerney Douglass Holloway Hunt, Yorktown Heights, NY (US); Kang-Won Lee, Nanuet, NY (US)

Correspondence Address: Rafael Perez-Pineiro;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/148,742

(22) Filed: Jun. 9, 2005

Related U.S. Application Data
(60) Provisional application No. 60/578,250, filed on Jun. 9, 2004.

(51) Int. Cl. G06F 17/00; H04K 1/00; H04L 9/00

(52) U.S. Cl. 726/1

(57) ABSTRACT

A system, apparatus and method for integrating policy-based technologies, including SLA management technologies, into an electronic utility (eUtility) infrastructure that supports automated provisioning of On Demand Service Environments (ODSEs) are provided. ODSEs embody the applications and computing resource services a subscribing customer requests. The system, apparatus and method augment the capabilities of eUtilities by defining the eUtilities in terms of policies that make them more customizable, and more responsive to the business objectives of the various parties that they serve.

### PRIORITY

This application claims the benefit of U.S. Provisional Application No. 60/578,250, filed Jun. 9, 2004.

### BACKGROUND OF THE INVENTION

1. Technical Field

The present invention relates to the field of digital computer systems, computer systems management, and resource management in large, distributed computer systems. This invention also relates to the fields of on-demand computing, autonomic computing, policy refinement, and policy-based management. More specifically, the present invention includes an improved computing system for providing policy-enabled electronic utilities.

2. Description of Related Art

An electronic utility, or “eUtility”, may be defined as a system for creating and managing multiple On Demand Service Environments (“ODSEs”) within a shared information technology infrastructure. Like traditional utilities, such as telephone and electricity, eUtilities are metered and customers pay for their use. The terms of use of the eUtilities include functionality, availability, performance, resources and reliability. These terms of use may vary from customer to customer and may change over time. This, in turn, necessitates dynamic monitoring of eUtilities, dynamic control over SLAs, and the ability to respond quickly to changing customer needs and available resources.

Because the operation of the eUtilities may change dynamically and may change often, it is important to simplify the manner by which such changes may be made. Therefore, there is a need in the art for a system and method that permits abstraction of the overall operation of these eUtilities such that the operation of the eUtilities may be easily modified.

### SUMMARY AND OBJECTS OF THE INVENTION

The present invention provides a system and method for policy-enabling eUtilities to augment the capabilities of the eUtilities by improving their ability for customization and responsiveness to the various business objectives of the parties served.

It is therefore a first object of the invention to provide a method that applies a policy-based software paradigm to an eutility architecture.

It is a second object of the invention to integrate policy technologies, including service level agreement (“SLA”) management technologies into the eutility infrastructure.

It is a third object of the invention to enable the specification of management operations in terms of higher level objectives rather than detailed device specific parameters.

The present invention focuses on the application of a policy-based software paradigm to a utility computing architecture, i.e., an e-Utility. The architecture of the present invention supports the provisioning of service environments that embody the applications and computing resources requested by subscribing customers. The systems and methods of the present invention use policies to augment the capabilities of an eUtility, making it more customizable and more responsive to the business objectives of the various parties involved.

These and other aspects, features, and advantages of the present invention will become apparent upon further consideration of the detailed description of the invention when read in conjunction with the drawings.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a distributed data processing environment in which some aspects of the present invention may be implemented;

FIG. 2 is an exemplary block diagram of a server computing device in which some aspects of the present invention may be implemented;

FIG. 3 is an exemplary block diagram of a client computing device in which some aspects of the present invention may be implemented;

FIG. 4 is an exemplary block diagram of a general policy framework;

FIG. 5 is an exemplary block diagram illustrating system components that are used as part of a policy creation methodology in accordance with one embodiment of the present invention;

FIG. 6 is an exemplary block diagram illustrating system components that are used as part of a policy deployment methodology in accordance with one embodiment of the present invention; and

FIG. 7 is an exemplary block diagram illustrating system components that are used as part of a policy enforcement methodology in accordance with one embodiment of the present invention.

### DETAILED DESCRIPTION OF THE PREFERRED EMBODIMENT

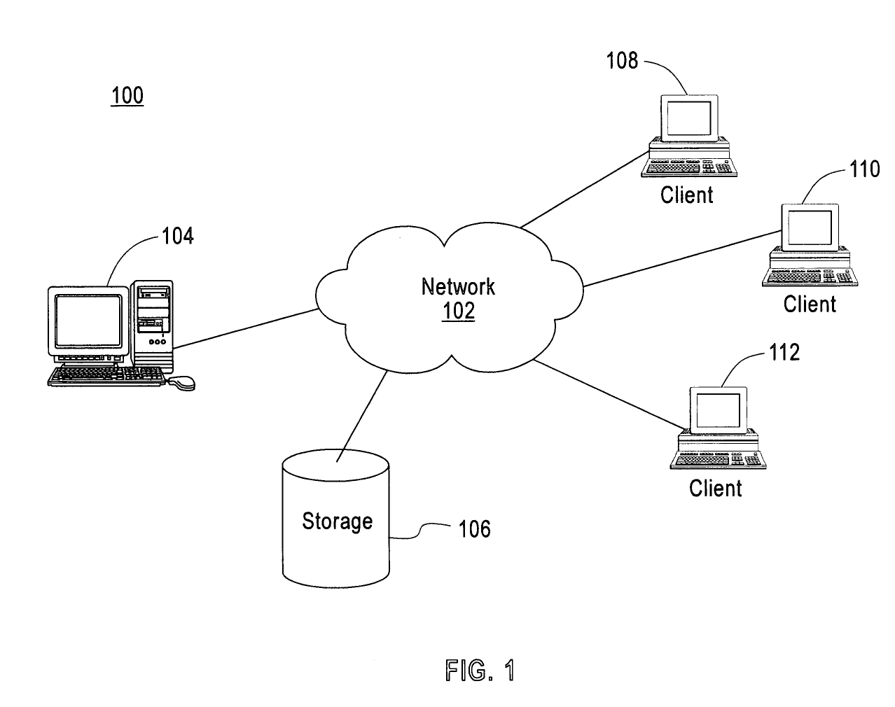

The present invention provides a system and method for policy-enabled electronic utilities (eUtilities). Such eUtilities are typically provided by service provider computing devices in a distributed data processing environment. Thus, the following FIGS. 1-3 are provided as example computing environments and devices in which aspects of the present invention may be implemented. FIGS. 1-3 are only intended to be exemplary and are not intended to state or imply any limitation on the type of computing devices in which the present invention may be implemented.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. The server 104 may be used, for example, with other servers (not shown) to support the eUtility service architecture in accordance with ne embodiment of the present invention.

Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

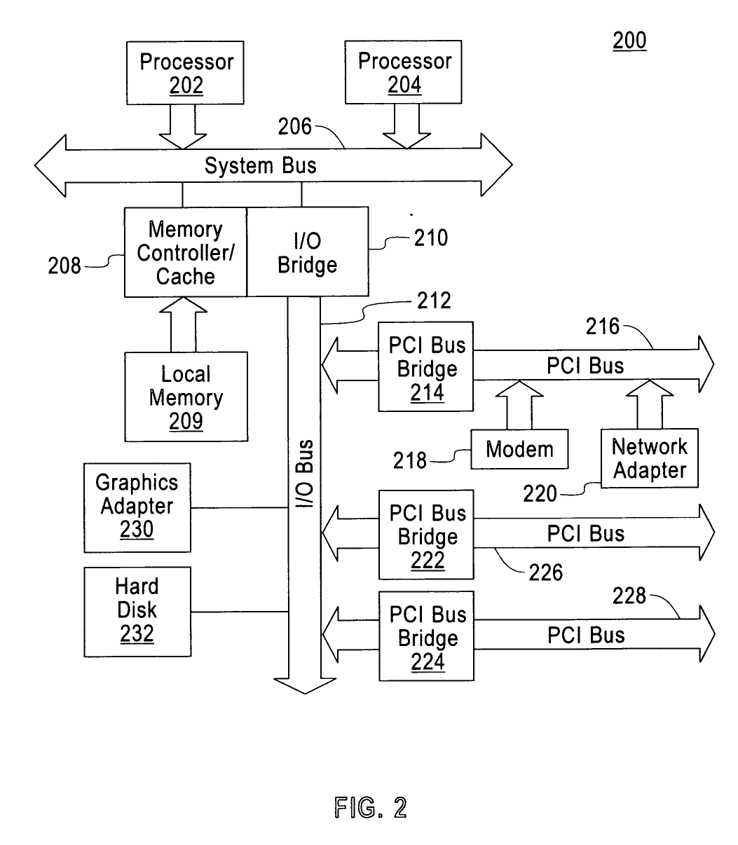

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

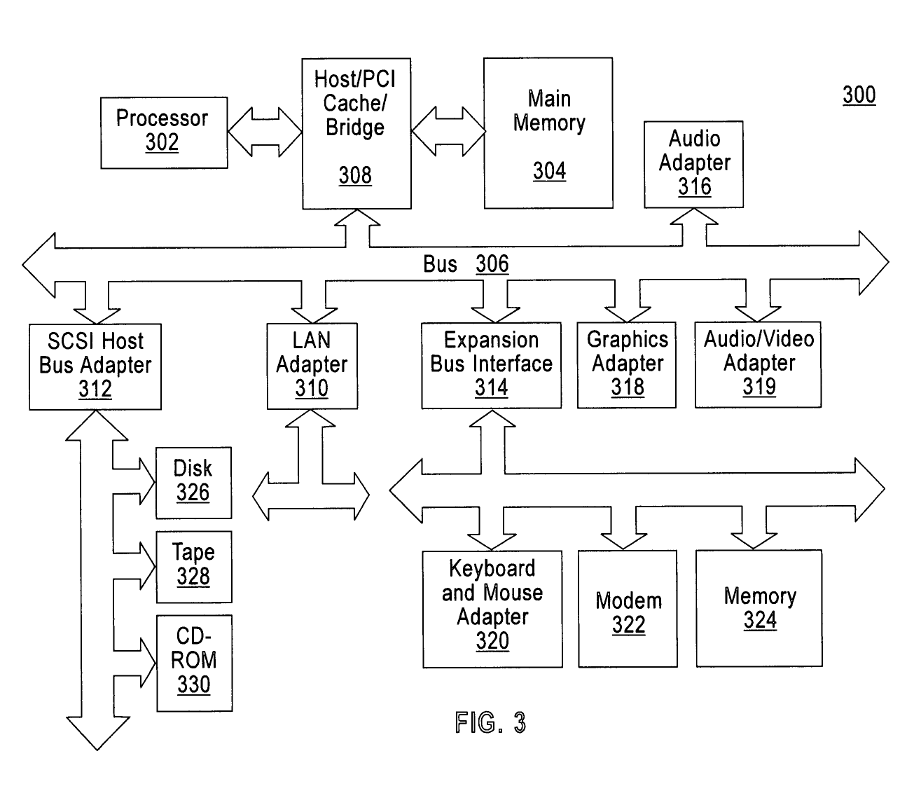

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Policy Architecture for a Computing-Utility

As stated above, the present invention provides a system and method for policy-enabling electronic utilities (eUtilities). A service provider (SP) may use computing devices responsible for providing the computing environment that is utilized by service applications and clients who wish to obtain the services provided by these service applications. These service providers have policies regarding how the computing environment is shared by service applications and clients. Policies may be defined as considerations designed to guide decisions on courses of action. For example, policies may specify which customers have priority to resources, how reservations are managed, how costs are allocated, etc. A service owner having different environment instances (aggregations of computing resources) may have policies regarding how instances should be configured and operated, how their performance should be measured, what to do in case of component failures, etc.

Resource Managers (RMs) may be defined as computing devices/applications that administer pools of specific computer resources. RMs may have policies regarding how resources are reserved, whether overbooking of resources is allowed, how resources are monitored, etc. Resource specific policies depend upon the attributes that have been externalized for particular resource types—storage systems have different characteristics that can be affected (e.g., space allocated, striping, access control) than networks (e.g., bandwidth allocation, packet drop rate). A policy framework provides a general, formalized way of controlling such customization and variability within a system through the use of policies.

The present invention provides a mechanism for merging a policy framework with an eutility architecture to obtain a policy-enabled eUtility. As mentioned above, an eutility is an application or device that creates and manages On-Demand Service Environments which provide application functions to customers. Each ODSE Offering defines an ODSE type that can be built and deployed on demand. Environments that are candidates for being instantiated as ODSEs are those that need a significant number of resources for a short period of time, those that have complex requirements so that users may not have the skills or time to deploy them, and those that have resource needs that vary over time and can take advantage of a shared resource pool. An eUtility can rapidly deploy complex ODSEs that dynamically adjust capacity autonomously using the services that the eutility provides.

Customers may subscribe to ODSE services using the Open Grid Services Architecture (“OGSA”) Business Provisioning Service (“OBPS”). The OBPS contains facilities supporting subscription, authentication, metering, Service Level Agreement (SLA) management, pricing, rating, and the like. In addition to the OBPS, the eUtility contains a Service Provider Manager (“SMP”). The SPM may build and manage the ODSEs.

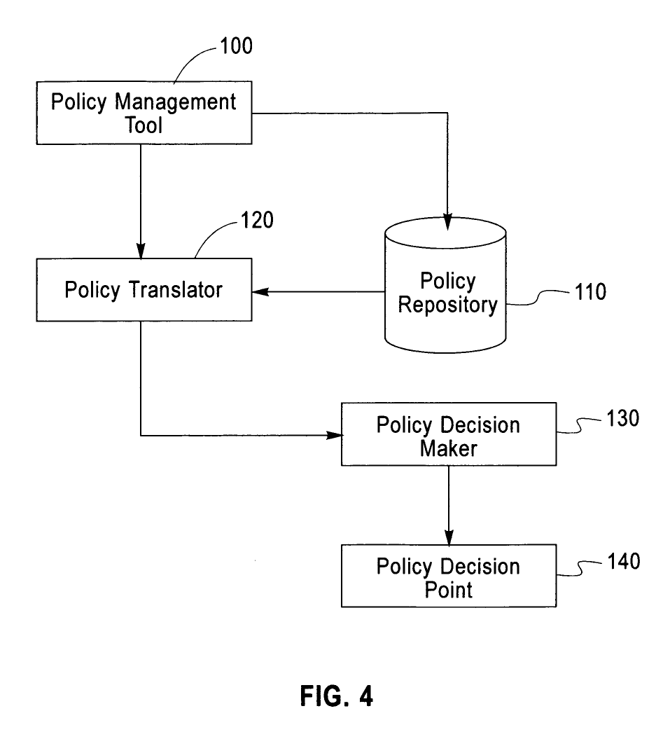

FIG. 4 is an exemplary block diagram illustrating a general policy-based administration framework. The policy-based framework shown in FIG. 4 is based on the Internet Engineering Task Force (IETF) adopted general policy-based administration framework. As shown in FIG. 4, the policy-based framework includes four elements: a policy management tool 100, a policy repository 110, a policy translator 120, and a policy decision maker (or enforcement point) 130. FIG. 4 also illustrates a policy decision point 140 which implements the decision and may be a device or system control point. Policy decision points may also store low level device specific policies.

Administrators define the policies that they wish to use in the operation of the system with the policy management tool 100, and these are stored in the policy repository 110. To ensure interoperability across products from different vendors, information stored in the policy repository 110 follows an information model specified by the Policy Framework Working Group of the IETF.

The policy decision makers (“PDMs”) 130 are the points within the system software at which policies are executed. Instead of communicating directly with the policy repository 110, PDMs 130 use intermediaries known as policy translators (PTs) 120. The PTs 120 interpret the policies stored in the policy repository 110 and communicate them to the associated policy targets in the appropriate format.

Associated PDMs 130 and policy decision points (“PDPs”) 140 may be in a single device or in different physical devices. Different protocols may be used for various parts of the architecture, e.g.: the Common Open Policy Service (COPS) protocol or the Simple Network Management Protocol (SNMP) may be used for communication between PTs 120 and PDMs 130, and the policy repository 110 may be implemented as a network directory server accessed using the Lightweight Directory Access Protocol (LDAP).

One of the advantages of a policy-based approach is that it simplifies the complex task of administering large, distributed systems by allowing the specification of management operations in terms of higher level objectives rather than detailed device specific parameters. The use of a logically centralized repository also enables detection of possible conflicts between the policies assigned to different devices.

Policies may be grouped according to disciplines, i.e., the particular aspects of a system that they have been created to support (e.g., network Quality of Service, or Intrusion Detection). Some aspects of applying policies to a given discipline are specific to the particular discipline, while others can be provided in a generic manner using a set of common algorithms and functions. Examples of capabilities that can be provided in a generic fashion are checking if a policy is valid (whether it conforms to the policy schema), determining whether a set of policies is consistent (checking for conflicts), checking if a policy is redundant (whether it is dominated by a combination of other policies), and determining if a policy is feasible (i.e., would it ever be executed).

Additionally, each PDM 130 (and, by client server relationship, each PT 120) in the system may take on one or more roles. Roles further refine policies within a discipline. Thus, for network Quality of Service (QoS), all access routers may have the role of “Edge” while all internal routers may have the role of “Core,” and they retrieve their respective policies from the policy repository 110 based upon their roles.

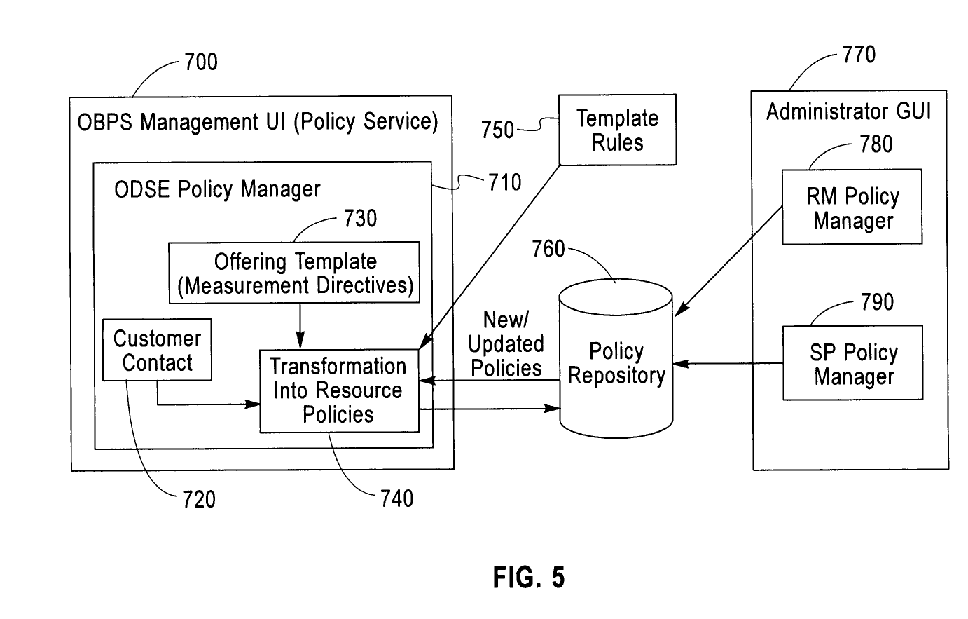

One embodiment of the present invention provides an eutility Infrastructure with a policy service. The policy service includes creation, deployment, and execution components as shown in FIGS. 5, 6, and 7 respectively.

The manner in which the policies at the different levels are created, deployed, updated, and enforced within the system is part of the policy architecture that is specified for every different type of eUtility. Certain “device-level” policies might be derivable from “domain-level” policies, or explicit transformations might be incorporated in the PEP specification. Alternatively, certain policies (like access control lists) may be specified at the “administrator-level” and simply passed through to the particular devices that needed them.

Referring to FIG. 5, the creation components of the policies are incorporated into the eUtility's OBPS service 700, the Administrator GUI 770, and a set of rule templates 750. Three policy managers within the creation component or service control access to policy creation and and maintenance for the three different types of policies in the system. These policy managers are the Service Provider Policy Manager 790, the ODSE Policy Manager 710, and the RM Policy Manger 780. The Service Provider Policy Manager 790 deals with the sharing of the computing infrastructure among different ODSs; ODSE Policy Manager 710 deals with policies particular to the allocation and management of computing resources supporting a given ODS; and the RM Policy Manger 780 deals with the administration of pools of specific resources.

The policy managers 710, 780 and 790 deal with policy information at a level of abstraction that is appropriate for interactions with a system administrator. This simplifies the complex task of administering the large, distributed system by allowing specification of management operations by the administrator in terms of higher level objectives rather than detailed device specific parameters. The policy schema between the discipline GUI plugin and the policy service manager thus captures policy information at that higher level.

Policy Managers combine policy fragments from a number of sources to build complete policies that can be stored in the Policy Repository 760. For example the ODSE policy manager 710 extracts policy fragments from a customer template 720 and combines them with policy fragments found in an associated offering template 730 and template rules 750. These fragments and rule templates are combined and transformed into resource policies 740, before they are stored in the policy repository 760.

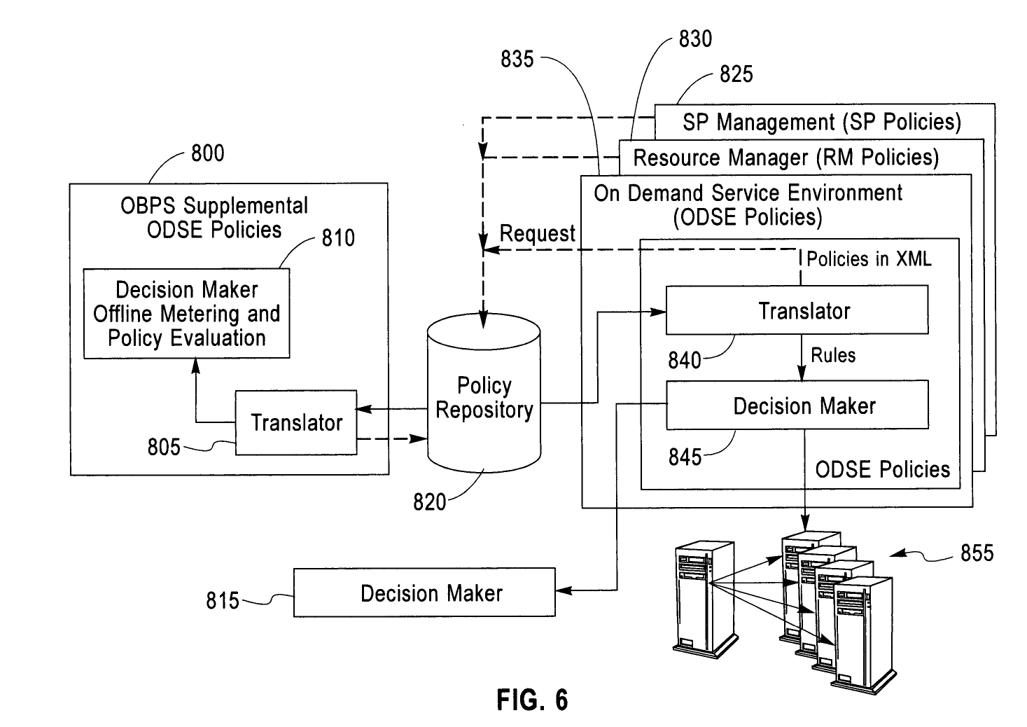

FIG. 6 is an exemplary diagram illustrating the policy deployment methodology in accordance with one embodiment of the present invention. As shown in FIG. 6, policy service agents (PSAs) 800, 825, 830 and 835 include a policy translator (840 or 805) and a policy decision maker (845 or 810). The PSAs 825, 830 and 835 are associated with each service provider (SP) 825, On-Demand Service 835 and Resource Manager 830 instance.

PSAs may be distributed. For example, the ODS PSA has an on-line component 835 that resides in the ODSE and an off-line component 800 that resides in the OBPS. Policy translators 840 interact with policy decision makers 845 that are responsible for the enforcement of policies particular to their specific context. PDMs may be dedicated to a particular resource type or handle multiple types.

Policies may be communicated via a common Policy Repository 820, where they are stored, for example, as XML documents. The policies consumed by a policy translator 840 may cover an administrative domain. If that is the case, the policy schema between the policy repository 820 and the translator 840 should be used at that domain level. The policies consumed by a policy decision point 855 specify device-specific rules for a particular functional area. A device-policy schema used between the PDM 845 and the decision point 855 reflects that system and capability specific information. The device-policy schema is not typically stored in the repository 820 and may take any proprietary form—from that of an XML schema to that of a set of system-specific configuration parameters.

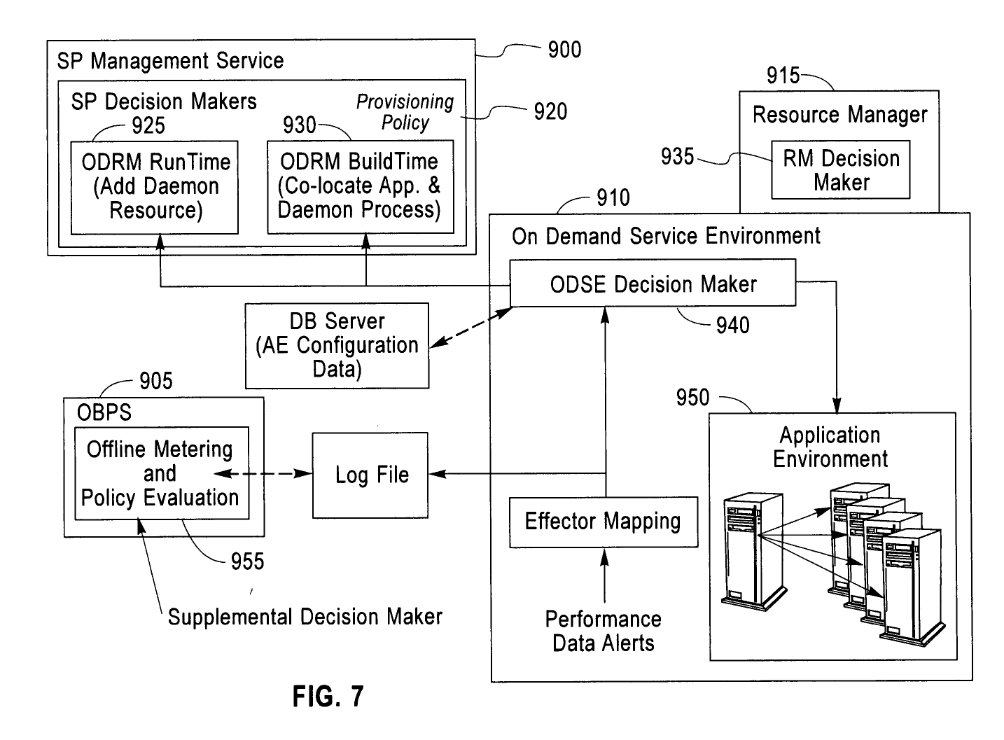

FIG. 7 is an exemplary diagram illustrating the policy enforcement methodology in accordance with one embodiment of the present invention. The enforcement component in the illustrated embodiment is implemented by the runtime section of the decision makers (920 for SP management server 900, 955 for OBPS 905, 935 for RM 915, and 940 for ODSE 910) which execute the policies.

After evaluating a policy, policy decision makers 940 may send commands to particular Policy Decision Points (PDPs) 950 that implement the decision, or elevate the problem to a higher level PDM (925,930) that has a broader perspective. For example, in the eutility architecture ODSE's pass requests to add resources to the SP management server 900 runtime policy decision maker (i.e. SP decision makers 920), which enforces resource distribution policies across multiple ODSEs. The policy architecture describes the logical components of the policy service. These may be implemented in various ways. For example, the PDMs for each ODSE may be provided by a single software component with knowledge of the different instances to which the policies are to be applied.

Policy Schema Classes

There are three principal categories of policies related to the provisioning of services within a computing utility: those that deal with the sharing of the computing infrastructure among different ODSs 825, those that deal with policies particular to a given ODS 835, 800; and those that deal with the administration of pools of specific resources 830. The general types of policies within each of these categories are listed below.

| | |
|---|---|
| SP Policies: 825 | |
| Resource Distribution Policy | Arbitration |
| Reservation Policy | How far in the future |
| Pricing Policy | Price of environment |
| RM Policies: 830 | |
| Overbooking Policy | What amount of overbooking is allowed |
| Forecasting Policy | Order new resources |
| Pricing Policy | Price of resource |
| Resource Monitoring Policy | Availability |
| RM Specific Policy | |
| ODSE Policies: 835, 800 | |
| Resource Acquisition Policy | Maximum number of servers/When to add |
| Failure Recovery Policy | Replacement policy |
| Pricing Policy | Price to ODSE user |
| Monitoring Policy | Aggregate metrics |
| Service Specific Policy | |

Each of these different types of policies will be described below. The list is not exhaustive, but provides examples of the kinds of considerations that may be applicable in computing utilities.

Service Provider Policies

The Service Provider may require policies for resource distribution, reservations, and pricing. Resource distribution policies may be used to arbitrate between the different demands of the service instances that are being provided within the overall shared computing infrastructure. They may be as simple as first come first served, or may involve priorities with preemptions (take from a lower priority instance to give to a higher priority instance), or penalty functions (take the resource from the instance that causes the least loss in revenue).

Reservation policies specify whether classes of resources can be reserved for use by a planned service, how far in advance reservations can be made, what happens if the service cannot be provisioned at the time promised, etc. Resource distribution and reservation policies interact with one another. The manner of interaction between services that are running and services that are reserved but not yet provisioned may be specified.

Pricing policies relates to issues such as the way in which customers are charged (flat fee, usage based, etc.), whether rebates apply and under what conditions, and whether refunds must be made if resource distribution and reservation policies are not appropriately met. These policies also interact with resource distribution and reservation policies, which implies that potential inconsistencies and conflicts must be resolved in the design of the policy architecture and the concomitant schemas.

RM Policies

Resource Manager (RM) policies that apply to the operation of the eUtility include those that deal with considerations like overbooking, forecasting, pricing, and monitoring. RMs administer pools of resources, and can execute various strategies in allocating them to ODSE instances. Overbooking policies specify whether resources that are associated with pending reservations can be over committed and, if so, what degree of risk is acceptable.

Forecasting policies determine when additional resources should be acquired. These forecasting policies can be based simply on the number of resources remaining idle or could be more complex and may incorporate projections of load or new reservation requests, for example.

Pricing policies, at the level of the resource managers, deals with how the costs of individual resources are ascribed to the specific instances to which they are allocated. This can be stated in terms of a given fixed price per resource based on a contractual commitment or can be calculated based on a number of other considerations (amount of use, replacement cost, number remaining in free pool, etc.), for example.

Monitoring policies describe the metrics that need to be provided, to whom they should be provided, and how often they should be provided. Typical metrics for computing resources include response times, loads, and utilizations. The RM policies interact among themselves, and also interact with the SP policies described above. The policy architecture needs to capture all these relationships.

In addition to the above types of policies that may be defined by an administrator of the computing utility, there are policies that manage the behavior of specific resources. These policies are specified by the RM developer, and affect the various controls externalized by the particular class of resource. Examples of these RM specific policies include server policies, storage policies, network policies, and the like.

For example, network policies may deal with such attributes as bandwidth, DiffServ marking, input and output queue scheduling priority at the endpoint servers on each link, TCP congestion window, VLAN configuration, VPN configuration, and the number of concurrent connections. Storage policies may deal with such attributes as storage allocation (size), data integrity, access control, response time, availability, request distribution (random or sequential), permanence, etc. Server policies may deal with such attributes as CPU utilization, I/O rates, degree of multi-processing, memory size, caching strategies, response time, availability, etc.

ODSE Policies

On Demand Service Environment (ODSE) policies capture considerations that apply to aggregations of resources allocated to a given ODS instance. Examples of such policies include policies for resource acquisition, failure recovery, pricing and monitoring. Resource acquisition policies may include considerations such as determining the time to ask for additional resources and, for cost containment purposes, determining the maximum number of resources allowed per service instance. Failure recovery policies may specify whether failed resources need to be replaced, whether checkpoints need to be taken and how often, whether hot standbys are required, etc.

The pricing policies, at the ODSE level, aggregate the resource costs and add in additional cost considerations due to overall service factors like congestion, failure, and Quality of Service (QoS) options. These pricing policies reflect the operation of the specific configuration of the multiple resources including the service and may even involve other services that are subsumed (e.g., a Web hosting service might incorporate a network communication service). These costs are taken into consideration by the ODSE owner when setting a pricing policy.

Monitoring policies again describe what metrics need to be provided, to whom they should be provided, and how often—but these are now specified with respect to the aggregate configuration (e.g., end-to-end response time).

In addition to the types of policies discussed above that deal with aspects of participation in the computing utility, there are policies defining the behavior of specific On Demand Service Environments that would need to be specified by the ODS developer. Examples of these ODS specific policies include provisioning constraints, workload management policy, metering, capacity planning policy, and the like. These policies relate to particular classes of service instances and the specific control points that they externalize.

Some of the desired categories of policies include policies for provisioning constraints, workload management, metering, capacity planning, and failure recovery. Provisioning constraints include such considerations as co-location (determining whether two resources should be hosted on the same server, or should they be on separate servers), and dependencies (does a particular software resource require another software resource or a particular type of hardware resource, does one software resource need to be started before another resource can start, etc.). Workload management policies deal with such considerations as the manner in which transactions are dispatched to clusters of servers, and the priorities assigned to different transaction classes.

To facilitate billing and accounting operations, the necessary usage and operational data must be metered. Metering policies determine what information needs to be gathered, how it needs to be summarized or otherwise combined, and where it is to be consumed. The metering rules support the overall pricing policies.

Capacity planning is necessary in order to determine or predict the need for additional resources to meet the operational goals of the service instance, given its system context. Capacity planning policies determine how to perform such predictions.

Autonomic Policy Generation

As described above, there are a number of different types of policies at a number of different levels of abstraction that need to be considered in the eUtility Infrastructure. Some of these policies may be specified in the SLAs associated with instances of On Demand Services. Other policies may be derived from business objectives in the SLAs. Still other policies may be specified by the Service Provider through an administrative console and some policies may be determined by the developers of the ODSEs and RMs that externalize specific decision points to which policies may be applied.

It is desirable to be able to derive policies from business objectives and derive lower level resource policies from higher level aggregate policies in as automated a manner as possible. The problem of determining the right set of underlying policies to meet a business objective can be solved in different ways depending upon the particulars of the required transformations. Below are described several methods for deriving policies from business objectives and deriving higher level policies from lower level policies that are included in the present invention.

Simple Transformations

In many circumstances, the mapping from higher level policies (or business objectives) to lower level policies can be done directly with simple transformations. This would be the case when information is only being refined as in a direct substitution (e.g., mapping domain names to IP addresses). This would also be the case when the higher level definition is actually a class definition that aggregates a number of different attributes at the lower level (e.g., associating a Class of Service like “Gold” to a given set of goals for network parameters like response time and packet loss rate). Even when higher level objectives are being mapped onto lower level policy constructs, the transformations may be simple. In determining the number of servers that are needed to meet a desired response time and the Class of Service (CoS) that each server must provide, a simple table of server characteristics might suffice, i.e., a simple transformation. Also, if the underlying system only supports a small number of alternative configurations, and a determination is being made as to which configuration is needed to meet a desired objective (e.g., an availability target), a simple search may be sufficient.

Analytic Models

For more complex transformations, if an analytic model can be developed that can be used to determine the business objective as a function of the underlying policies, one could solve for the model parameters that would satisfy the required business parameters. For example, if an analytical expression existed to determine the outbound bandwidth needed to support a given inbound traffic rate at a website, the expression could be inverted to obtain the requisite traffic rate for any desired limit on outbound bandwidth. That is to say, if there.exists a known closed form expression for the function ƒ, where ƒ(p)=b and p is a vector of policy values, it is possible to use numerical or other techniques to find the values for the components of the policy vector p that attain the value b.

Generic Models

For certain performance characteristics, like response time and throughput, computing systems are often modeled as queuing networks. Under certain sets of simplifying assumptions these can be solved analytically, but most often are solved by simulation techniques. Given such a parameterized model, one could solve for the model parameters that would satisfy the required business parameters.

Online Adaptive Control

Other classes of parameterized models, like those based on concepts from control theory or statistical techniques like linear regression, can be used to determine and fine-tune the parameters needed to obtain a given business objective. Neural networks could also be used to determine the impact of specific policy parameters on the requisite business objective. The neural network or the adaptive control scheme could then be used to dynamically adapt policy parameters to meet the desired goals in the running system. This approach is fairly flexible, but generally requires extensive training data.

Case Based Reasoning

In certain instances it may be possible to use learning techniques to develop implicit models of system behavior. In a Case Based Reasoning (CBR) approach, the settings for system parameters that attain certain goals would be learned experientially from historical data. A database of past cases is maintained, where each case is a combination of the policy parameters and the business objectives that were achieved when those parameter values were used. In order to determine the set of policies that would be needed to achieve a new business objective, the case database is searched to find the closest matching case, or an interpolation is performed between existing cases that bracket the new requirement, to establish the appropriate settings. The definitions of the cases, and the strategies for interpolation may be specific to the particular policy discipline being considered. However, the same case manipulation software and algorithms can be used across different disciplines.

The CBR approach depends on extensive historical data in order to build a rich enough set of cases that can be consulted to guide new decisions. In a system that has been running for an extended period of time, it is possible to build cases from prior experience. However, at bootstrap time, there is no prior experience to exploit. Thus, a CBR approach needs to be combined with some heuristic approach to be used until enough historical data is collected (an analytical expression or approximation), or the system has to be pre-populated with a set of cases synthetically derived or obtained experimentally.

Thus, the present invention provides architectural extensions to the eUtility infrastructure that enable the use of policy-based computing technologies. Methodologies for creating, deriving, deploying and enforcing various classes of policies that are useful within a shared resource infrastructure are provided. By providing a policy-based eutility using the mechanisms herein described, the present invention provides a more customizable and dynamically changeable eUtility than has been previously known before.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for incorporating a policy architecture into a utility computing architecture comprising:
creating a policy repository;
deploying policies from the policy repository into the utility computing architecture; and
enforcing said deployed policies in the utility computing architecture.

2. The method of claim 1, wherein creating a policy repository comprises:
extracting first policy fragments from a customer template;
extracting second policy fragments from an offering template;
combining said first and second policy fragments with template rules and transforming the combined fragments and rules into resource policies; and
storing said resource policies into the policy repository.

3. The method of claim 2, wherein said resource policies are on-demand service environment policies pertaining to allocation and management of computing resources supporting an on-demand service.

4. The method of claim 2, further comprising:
storing in the policy repository service provider policies pertaining to sharing a computing infrastructure among different on-demand services.

5. The method of claim 2, further comprising:
storing in the policy repository resource manager policies pertaining to administration of pools of specific resources.

6. The method of claim 1, wherein deploying policies comprises:
sending domain-level policies from the policy repository to a policy service agent; and
translating said domain-level policies to device-level policies.

7. The method of claim 1, wherein enforcing policies comprises:
evaluating a device-level policy;
deciding whether the policy can be implemented; and
sending commands to a policy decision point that implements the decision.
